(19) United States
(12) Patent Application Publication
(10) Pub. No.: US 2023/0080211 A1
(43) Pub. Date: Mar. 16, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Satoshi Nagata, Tokyo (JP); Lihui Wang, Beijing (CN)

(73) Assignee: NTT DOCOMO, INC., Tokyo (JP)

(21) Appl. No.: 17/799,140

(22) PCT Filed: Feb. 13, 2020
(86) PCT No.: PCT/JP2020/005644

§ 371 Date: Aug. 11, 2022

(51) Int. Cl. H04W 24/10; H04W 72/04; H04W 72/12

(52) U.S. Cl. CPC H04W 24/10; H04W 72/0413; H04W 72/1289

(57) ABSTRACT

A terminal according to an aspect of the present disclosure includes: a reception section that receives information on a physical uplink control channel (PUCCH) resource by at least one of downlink control information and a radio resource control information element; and a control section that reports aperiodic channel state information (A-CSI) by using the PUCCH resource. According to one aspect of the present disclosure, the A-CSI reporting can be appropriately performed.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing a data rate, providing low latency, and the like (see Non Patent Literature 1). Further, the specifications of LTE-Advanced (third generation partnership project (3GPP) Release. (Rel.) 10 to 14) have been drafted for the purpose of further increasing capacity and advancement of LTE (3GPP Rel. 8 and 9).

Successor systems to LTE (for example, also referred to as 5th generation mobile communication system (5G), 5G+(plus), 6th generation mobile communication system (6G), New Radio (NR), or 3GPP Rel. 15 or later) are also being studied.

In the existing LTE systems (for example, 3GPP Rel. 8 to 14), a user terminal (user equipment (UE)) uses at least one of a UL data channel (for example, physical uplink shared channel (PUSCH)) and a UL control channel (for example, physical uplink control channel (PUCCH)) to transmit uplink control information (UCI).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In a future radio communication system (for example, NR), the UE may report aperiodic channel state information (A-CSI) on the PUSCH.

For example, more DL transmissions may be required, which results in fewer A-CSI reports. If the A-CSI reporting is not appropriately performed, a communication throughput may decrease.

Therefore, an object of the present disclosure is to provide a terminal, a radio communication method, and a base station for appropriately performing A-CSI reporting.

### Solution to Problem

A terminal according to an aspect of the present disclosure includes: a reception section that receives information on a physical uplink control channel (PUCCH) resource by at least one of downlink control information and a radio resource control information element; and a control section that reports aperiodic channel state information (A-CSI) by using the PUCCH resource.

### Advantageous Effects of Invention

According to one aspect of the present disclosure, the A-CSI reporting can be appropriately performed.

### BRIEF DESCRIPTION OF DRAWINGS

FIG. 1 is a diagram illustrating an example of CSI report configuration.

FIG. 2 is a diagram illustrating an example of a PUCCH resource for P-CSI reporting or SP-CSI reporting.

FIG. 3 is a diagram illustrating an example of an RRC parameter indicating a PUCCH resource for A-CSI.

FIG. 4 is a diagram illustrating an example of a schematic configuration of a radio communication system according to an embodiment.

FIG. 5 is a diagram illustrating an example of a configuration of a base station according to an embodiment.

FIG. 6 is a diagram illustrating an example of a configuration of a user terminal according to an embodiment.

FIG. 7 is a diagram illustrating an example of a hardware configuration of the base station and the user terminal according to an embodiment.

### DESCRIPTION OF EMBODIMENTS

(CSI Report or Reporting)

In Rel. 15 NR, a terminal (also referred to as a user terminal, user equipment (UE), or the like) generates (also referred to as determine, calculate, estimate, measure, or the like) channel state information (CSI) based on a reference signal (RS) (or a resource for the RS), and transmits (also referred to as report, feedback, or the like) the generated CSI to a network (for example, a base station). The CSI may be transmitted to the base station by using a physical uplink control channel (PUCCH) or a physical uplink shared channel (PUCCH).

It is sufficient that the RS used for generating the CSI is at least one of a channel state information reference signal (CSI-RS), a synchronization signal/physical broadcast channel (SS/PBCH) block, a synchronization signal (SS), and a demodulation reference signal (DMRS).

The CSI-RS may include at least one of non zero power (NZP) CSI-RS and CSI-interference management (IM). The SS/PBCH block is a block including a SS and a PBCH (and a corresponding DMRS), and may be referred to as an SS block (SSB) or the like. The SS may include at least one of a primary synchronization signal (PSS) and a secondary synchronization signal (SSS).

The CSI may include at least one of parameters (CSI parameters) including a channel quality indicator (CQI), a precoding matrix indicator (PMI), a CSI-RS resource indicator (CRI), an SS/PBCH block resource indicator

(SSBRI), a layer indicator (LI), a rank indicator (RI), layer 1 reference signal received power (L1-RSRP), L1-reference signal received quality (RSRQ), an L1-signal-to-noise and interference ratio (or signal to interference plus noise ratio) (L1-SINR), an L1-signal to noise ratio (SNR), and the like.

The UE may receive information (report configuration information) regarding CSI reporting and control the CSI reporting based on the report configuration information. The report configuration information may be, for example, “CSI-ReportConfig” as an information element (IE) of radio resource control (RRC). In the present disclosure, the RRC-IE may be rephrased as an RRC parameter, a higher layer parameter, or the like.

The report configuration information (for example, “CSI-ReportConfig” as the RRC-IE) may include, for example, at least one of the following.
Information regarding the type of the CSI reporting (report type information, for example, “reportConfigType” as the RRC-IE)
Information regarding one or more quantities of CSI (one or more CSI parameters) to be reported (report quantity information, for example, “reportQuantity” as the RRC-IE)
Information regarding an RS resource used to generate the quantity (the CSI parameter) (resource information, for example, “CSI-ResourceConfigId” as the RRC-IE)
Information regarding a frequency domain to be subjected to the CSI reporting (frequency domain information, for example, “reportFreqConfiguration” as the RRC-IE)

For example, the report type information may indicate periodic CSI (P-CSI) reporting, aperiodic CSI (A-CSI) reporting, or semi-permanent (semi-persistent) CSI (SP-CSI) reporting.

In addition, the report quantity information may specify at least one combination of the CSI parameters (for example, CRI, RI, PMI, CQI, LI, L1-RSRP, and the like).

Further, the resource information may be an ID of the RS resource. The RS resource may include, for example, a non-zero power CSI-RS resource, an SSB, and a CSI-IM resource (for example, a zero-power CSI-RS resource).

In addition, the frequency domain information may indicate frequency granularity of the CSI reporting. The frequency granularity may include, for example, a wideband and a subband. The wideband is an entire CSI reporting band. The wideband may be, for example, an entire given carrier (component carrier (CC), cell, or serving cell) or an entire bandwidth part (BWP) in a given carrier. The wideband may be rephrased as a CSI reporting band, an entire CSI reporting band, or the like.

In addition, the subband is a part in the wideband, and may include one or more resource blocks (RB) or physical resource blocks (PRB). The size of the subband may be determined according to the size of the BWP (the number of PRBs).

The frequency domain information may indicate which one of a PMI of the wideband and a PMI of the subband is to be reported (the frequency domain information may include, for example, “pmi-FormatIndicator” as the RRC-IE used to determine either the wideband PMI reporting or the subband PMI reporting). The UE may determine the frequency granularity (that is, any one of the wideband PMI reporting or the subband PMI reporting) of the CSI reporting based on at least one of the report quantity information and the frequency domain information.

In a case where the wideband PMI reporting is configured (determined), one wideband PMI may be reported for the entire CSI reporting band. On the other hand, in a case where the subband PMI reporting is configured, a single wideband indication i₁ may be reported for the entire CSI reporting band, and one subband indication i₂ (for example, a subband indication of each subband) of each of one or more subbands within the entire CSI reporting band may be reported.

The UE performs channel estimation by using the received RS, and estimates a channel matrix H. The UE feedbacks an index (PMI) that is determined based on the estimated channel matrix.

The PMI may indicate a precoder matrix (also simply referred to as a precoder) that is considered by the UE as being appropriate for downlink (DL) transmission to the UE. Each value of the PMI may correspond to one precoder matrix. A set of values of the PMI may correspond to a set of different precoder matrices, that is called a precoder codebook (also simply referred to as codebook).

In a space domain, the CSI report may include one or more types of CSI. For example, the CSI may include at least one of a first type (Type 1 CSI) used for selection of a single beam and a second type (Type 2 CSI) used for selection of multiple beams. The single beam may be rephrased as a single layer, and the multiple beams may be rephrased as a plurality of beams. The Type 1 CSI is not required to assume multiuser multiple input multiple output (MIMO), and the Type 2 CSI may assume the multiuser MIMO.

The codebook may include a codebook for the Type 1 CSI (also referred to as Type 1 codebook or the like) and a codebook for the Type 2 CSI (also referred to as Type 2 codebook or the like). In addition, the Type 1 CSI may include a Type 1 single-panel CSI and a Type 1 multi-panel CSI, and different codebooks (Type 1 single-panel codebook and Type 1 multi-panel codebook) may be defined.

In the present disclosure, Type 1 and Type 1 may be interchangeable. In the present disclosure, Type 2 and Type II may be interchangeable.

The type of uplink control information (UCI) may include at least one of hybrid automatic repeat request acknowledgement (HARQ-ACK), a scheduling request (SR), and CSI. The UCI may be carried on a PUCCH or a PUSCH.

In Rel. 15 NR, the UCI may include one CSI part for wideband PMI feedback. A CSI report #n includes PMI wideband information if reported.

In Rel. 15 NR, the UCI may include two CSI parts for subband PMI feedback. A CSI part 1 includes wideband PMI information. A CSI part 2 includes one piece of wideband PMI information and several pieces of subband PMI information. The CSI part 1 and the CSI part 2 are separately encoded.

CSI feedback on ultra-reliable and low latency communications (URLLC)/industrial internet of things (IIoT) has been considered. In particular, extension of CSI feedback (reporting) for more accurate selection of a modulation and coding scheme (MCS) has been considered in order to satisfy URLLC requirements.

For this purpose, A-CSI on PUCCH has been studied. The A-CSI in the existing system is carried only on the PUSCH scheduled by a UL grant. In addition, a method of reducing the latency of the CSI reporting so as to reduce the number of required simultaneous CSI reports has been studied. In Rel. 15 and Rel. 16, five simultaneous transmissions are supported. In addition, a method for enabling a faster timeline for CSI triggering and reporting has been studied.

In a case where the CSI reporting for URLLC is based on P-CSI, a short reporting period should be set. This leads to high UL overhead and UE power consumption. URLLC traffic is sporadic.

As described above, in an existing system, the A-CSI is carried only on the PUSCH triggered by a UL grant. Assuming a large number of DL transmissions, A-CSI on PUSCH cannot be triggered frequently because resources for DL transmission are required. In a case where the base station cannot obtain the CSI feedback, the base station needs to schedule DL URLLC transmission in the most conservative manner of resource assignment and MCS level, which results in a decrease in resource utilization efficiency.

Therefore, the A-CSI on PUCCH is preferably supported.

In Rel. 15 and Rel. 16, a frequency domain resource and a time domain resource for A-CSI are indicated by frequency domain resource assignment (FDRA) and time domain resource assignment (TDRA) fields in a DCI format 0_1 or 0_2.

A CSI request field in the DCI format 0_1/0_2 indicates a request for transmission of the A-CSI on the PUSCH. The CSI request field includes up to six bits. Each of the configured A-CSI reports is associated with a particular bit combination (field value). The CSI request field allows 63 different A-CSI report configurations to be triggered, except for an all 0 value indicating “no triggering”.

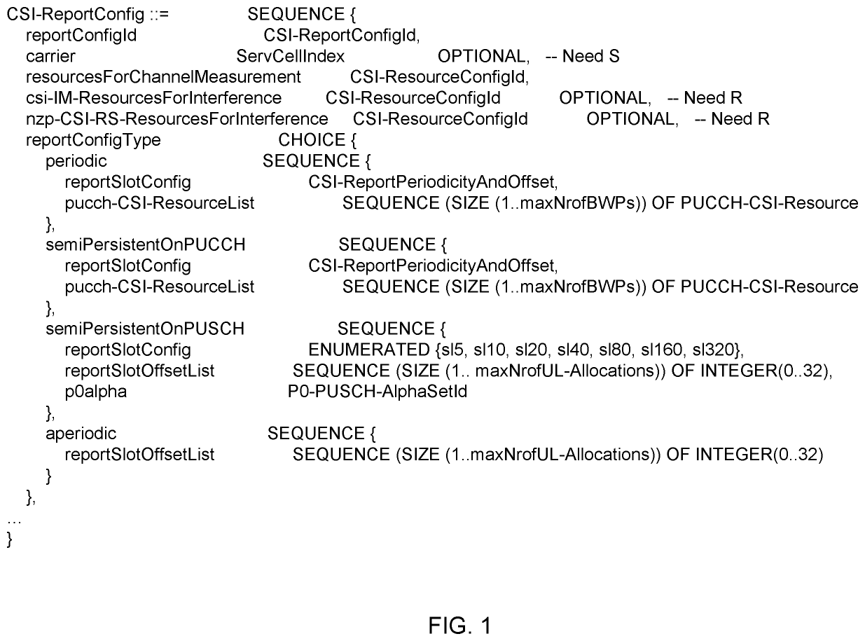

As illustrated in FIG. 1, one or more PUCCH resources for P-CSI and SP-CSI are configured by a PUCCH-CSI resource list (PUCCH-CSI-ResourceList) in the CSI report configuration (CSI-ReportConfig). The PUCCH-CSI resource list indicates which PUCCH resource is used for reporting on the PUCCH.

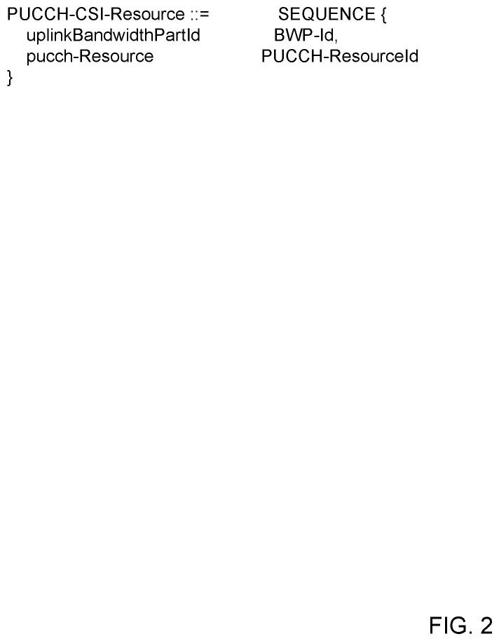

As illustrated in FIG. 2, one PUCCH resource per BWP (UL BWP ID) is configured by PUCCH resource information (PUCCH-CSI-Resource) in the PUCCH-CSI resource list. Depending on a UCI payload size, a PUCCH format 2/3/4 is used.

As described above, in the existing system, one PUCCH resource is configured for each BWP for each of P-CSI on PUCCH and SP-CSI on PUCCH. For SP-CSI/A-CSI on PUSCH, a PUSCH resource is indicated by the DCI. However, it is not clear how to prepare/schedule PUCCH resources for the A-CSI on PUCCH. In addition, it is not clear how to configure a resource for the A-CSI on PUCCH and triggering of the A-CSI on PUCCH. If the A-CSI is not appropriately transmitted, the communication throughput may decrease.

The A-CSI on PUSCH, the SP-CSI on PUSCH, the SP-CSI on PUCCH, and the P-CSI on PUCCH are prioritized in this order. In a case where time occupancies of two physical channels scheduled to carry two CSI reports overlap in at least one OFDM symbol and are transmitted on the same carrier, such a case may be expressed as collision of the two CSI reports.

In a case where the A-CSI on PUCCH is supported, there are the following problems.

It is not clear whether the A-CSI on PUCCH is triggered by DL grant DCI (DL DCI) or UL grant DCI (UL DCI). The A-CSI on PUCCH is preferably triggered dynamically. The A-CSI on PUSCH is triggered by the DCI.

In a case where the A-CSI on PUCCH is triggered by the DCI including the DL grant or the UL grant, it is not clear whether or not the DCI schedules data (PDSCH or PUSCH) for the UE.

It is not clear whether or not the A-CSI on PUSCH is supported/configured together with the A-CSI on PUCCH. In a case where both the A-CSI on PUCCH and the A-CSI on PUSCH are supported at the same time, it is not clear how to handle a collision therebetween. For example, it is not clear how to prioritize them or how to multiplex them.

Therefore, the present inventors have conceived a method for appropriately reporting the A-CSI on PUCCH.

Hereinafter, embodiments according to the present disclosure will be described in detail with reference to the drawings. A radio communication method according to each of the embodiments may be applied independently, or may be applied in combination with others.

In the present disclosure, “A/B” and “at least one of A and B” may be interchangeable. In the present disclosure, a cell, a CC, a carrier, a BWP, and a band may be interchangeable. In the present disclosure, an index, an ID, an indicator, and a resource ID may be interchangeable. In the present disclosure, an RRC parameter, a higher layer parameter, an RRC information element (IE), and an RRC message may be interchangeable.

In the present disclosure, a UL grant, UL DCI, and DCI for PUSCH scheduling may be interchangeable. In the present disclosure, a DL grant, DL DCI, and DCI for PDSCH scheduling may be interchangeable.

In the present disclosure, the A-CSI on PUCCH, the A-CSI reporting on PUCCH, and the A-CSI on PUCCH may be interchangeable. In the present disclosure, the A-CSI on PUSCH, the A-CSI reporting on PUSCH, and the A-CSI on PUSCH may be interchangeable.

(Radio Communication Method)

### Embodiment 1

The PUCCH resource for the A-CSI may be specified/configured by at least one of the following PUCCH resource notification methods 1 and 2.

<<PUCCH Resource Notification Method 1>>

The PUCCH resource for the A-CSI may be indicated by the DCI. The PUCCH resource for the A-CSI may be partially configured by using the RRC parameter.

For the UE, the PUCCH resource for the A-CSI may be indicated by the DCI field in the DCI format for the UL grant and the DL grant.

The DCI format may be at least one of 0_0, 0_1, 0_2, 1_0, 1_1, 1_2, and a new DCI format.

The DCI may indicate resource allocation for the A-CSI, or may indicate another parameter.

The DCI may indicate the PUCCH resource according to any one of the following indication methods 1 and 2.

[Indication Method 1]

The PUCCH resource may be directly indicated by the DCI field. The time domain resource and the frequency domain resource for the PUCCH may be based on the TDRA and FDRA fields, respectively.

[[Scheduling Limitation]]

A scheduling limitation of the PUCCH may be according to a scheduling limitation for the PUCCH format. At least one of the number of symbols and the number of resource blocks (RBs) may be limited for the PUCCH format.

[[No Scheduling Limitation]]

The time domain resource and the frequency domain resource for the PUCCH may have no scheduling limitation. The time domain resource and the frequency domain resource may be scheduled by using a similar allocation method to the PUSCH or the PDSCH.

A code domain resource for the PUCCH may be indicated by the DCI field if necessary, or may be configured by the RRC parameter. The code domain resource may be at least one of an orthogonal cover code (OCC) (at least one of a length or an index), or an initial cyclic shift index.

Whether or not frequency hopping is applied may be indicated by a frequency hopping flag field in the DCI.

[Indication Method 2]

Only the PUCCH format may be indicated by the DCI. Other parameters for the PUCCH resource may be configured by the RRC parameter similarly to the existing PUCCH resource.

The RRC parameter for the PUCCH resource for the A-CSI may include at least one of a start PRB index, activation of intra-slot frequency hopping, a second-hop PRB index, the initial cyclic shift index, the number of symbols, a start symbol index, a time-domain OCC index, an OCC length, and an OCC index.

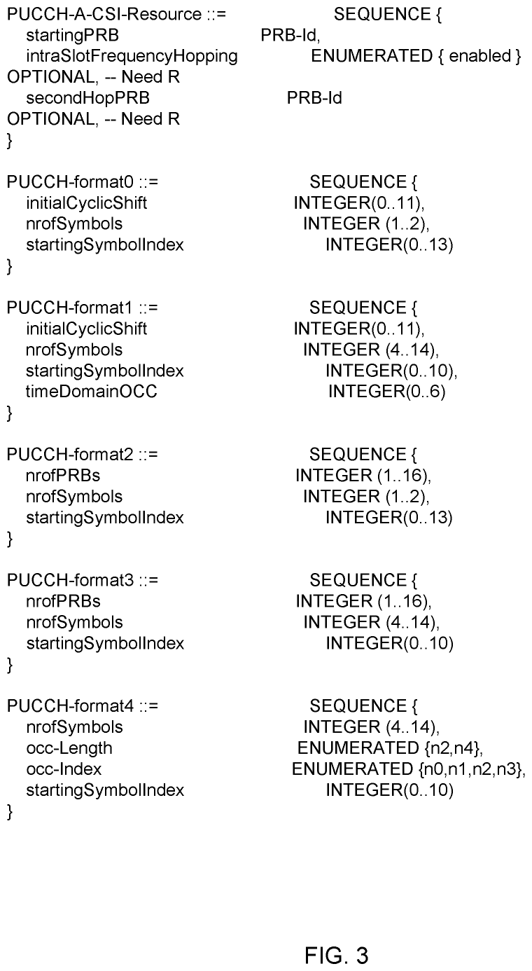

For example, as illustrated in FIG. 3, the RRC parameter indicating the PUCCH resource for the A-CSI may include a parameter common to a plurality of PUCCH formats and a parameter dedicated to each PUCCH format. The common parameter (for example, PUCCH-A-CSI-Resource) may include at least one of the start PRB index, the activation of the intra-slot frequency hopping, and the second-hop PRB index. The dedicated parameter (for example, at least one of PUCCH-format 0, PUCCH-format 1, PUCCH-format 2, PUCCH-format 3, and PUCCH-format 4) may include at least one of the initial cyclic shift index, the number of symbols, the start symbol index, the time-domain 0CC index, the 0CC length, and the 0CC index.

<<PUCCH Resource Notification Method 2>>

The PUCCH resource for the A-CSI may be indicated by the RRC parameter. The PUCCH resource for the A-CSI may be partially configured by using the DCI.

For the UE, the PUCCH resource for the A-CSI may be configured by using a higher layer parameter. The number of PUCCH resources may be according to any one of the following PUCCH resource allocations 1 and 2.

[PUCCH Resource Allocation 1]

One PUCCH resource may be configured per BWP.

For the UE, the RRC parameter may be configured. For example, in the CSI report configuration (RRC parameter CSI-ReportConfig), one PUCCH resource associated with a BWP ID is configured for the A-CSI.

The PUCCH resource may be scheduled to different positions in both the frequency domain and the time domain for each time unit according to a rule or a formula. The time unit may be at least one of a slot and a symbol.

The A-CSI reporting is performed aperiodically. It may be referred to as the A-CSI on PUCCH.

According to the PUCCH resource allocation, the PUSCH can use a resource that is not assigned to the PUCCH for the A-CSI. Therefore, resource utilization efficiency can be enhanced. Further, according to the PUCCH resource allocation, there is no overhead of the DCI indication.

[PUCCH Resource Allocation 2]

More than one PUCCH resource may be configured per BWP.

For the UE, the RRC parameter may be configured. For example, in the CSI report configuration (RRC parameter CSI-ReportConfig), a plurality of PUCCH resource associated with a BWP ID are configured for the A-CSI.

The UE may transmit the A-CSI by using one or more PUCCH resources.

The UE may determine a resource to be used among the plurality of configured PUCCH resources according to a rule or a formula.

For the UE, among the plurality of configured PUCCH resources, a resource to be used may be indicated by the DCI.

One field in the DCI used for at least one of the DL grant and the UL grant may indicate a PUCCH resource to be used. For example, the field may be a PUCCH resource indicator (PRI). A field for indicating the PUCCH resource may be any of the following fields 1 and 2.

[[Field 1]]

In addition to the PRI field for HARQ-ACK, a PRI field for the A-CSI (A-PRI) may be used.

In the present disclosure, the PRI and the A-PRI may be interchangeable.

[[Field 2]]

The same PRI field may be used for the HARQ-ACK and the A-CSI. Whether the PRI is for the HARQ-ACK or for the A-CSI may be recognized by at least one of the following field recognition methods 1 to 4.

[[[Field Recognition Method 1]]]

The UE may determine whether the PRI is for the HARQ-ACK or for the A-CSI based on a field value of the PRI.

The PRI may be extended to a size larger than 3 bits. In this case, when the PRI value is 8 or more, the UE may interpret that the PRI indicates the PUCCH resource for the A-CSI. When the PRI value is less than 8, the UE may interpret that the PRI indicates the PUCCH resource for the HARQ-ACK.

[[[Field Recognition Method 2]]]

The UE may determine whether the PRI is for the HARQ-ACK or for the A-CSI according to the RRC parameter.

[[[Field Recognition Method 3]]]

The UE may determine whether the PRI is for the HARQ-ACK or for the A-CSI based on a value of a specific field in the DCI including the PRI. For example, the specific field may be the CSI request field. When the CSI field value is 1, the PRI may indicate the PUCCH resource for the A-CSI. Otherwise, the PRI may indicate the PUCCH resource for the HARQ-ACK.

[[[Field Recognition Method 4]]]

The UE may determine whether the PRI is for the HARQ-ACK or for the A-CSI based on the DCI including the PRI. When information based on the DCI is a specific value, the PRI may indicate the PUCCH resource for the A-CSI. Otherwise, the PRI may indicate the PUCCH resource for the HARQ-ACK. The information based on the DCI may be a radio network temporary identifier (RNTI) used for scrambling of a CRC included in the DCI, or may be a DCI format of the DCI.

Among the plurality of PUCCH resources configured for the A-CSI, a PUCCH resource other than the PUCCH resource used for transmission of the A-CSI may be used for other UCI (may be shared). The other UCI may be at least one of the P-CSI, the SP-CSI, the HARQ-ACK, and the scheduling request (SR).

All or some of the plurality of PUCCH resources configured for the A-CSI may be used for other reports (may be shared). For example, in a case where transmission timings of the A-CSI and the other UCI overlap, at least one of the A-CSI and the other UCI may be transmitted according to any one of the following PUCCH resource use methods 1 and 2.

[[PUCCH Resource Use Method 1]]

In a case where the PUCCH resource is used for the A-CSI, the A-CSI may be prioritized (other UCI may be pre-empted).

[[PUCCH Resource Use Method 2]]

The A-CSI and the other UCI may be multiplexed.

The UE may transmit the A-CSI by using all of the plurality of PUCCH resources configured for the A-CSI. By doing so, the operation of the UE can be simplified.

According to Embodiment 1, the UE can properly configure/indicate the PUCCH resource for the A-CSI on PUCCH.

### Embodiment 2

The A-CSI on PUCCH may be triggered by at least one of the following triggering methods 1 and 2.

<<Triggering Method 1>>

A separate triggering for the A-CSI on PUCCH is not required. The UE may interpret the PRI indication as the triggering of the A-CSI.

The PRI may be extended to a size larger than 3 bits. In this case, when the PRI value is 8 or more, the UE may interpret that the PRI indicates the PUCCH resource for the A-CSI and the triggering of the A-CSI. When the PRI value is less than 8, the UE may interpret that the PRI indicates the PUCCH resource for the HARQ-ACK.

The UL grant in Rel. 16 does not include the PRI. Therefore, a UL grant including the PRI may be introduced. Both DL and UL grants may be used for A-CSI triggering.

<<Triggering Method 2>>

The A-CSI on PUCCH is triggered by the DCI.

A request field may trigger the A-CSI on PUCCH. The request field may be the existing CSI request field, or may be a newly introduced A-CSI request field. In a case where the request field is the same as that for the A-CSI on PUSCH, the UE may determine whether the request field is for the A-CSI on PUSCH or for the A-CSI on PUCCH based on the RRC parameter or one or more specific fields. For example, the specific field may be a field similar to activation DCI of a configured grant (PUSCH). For example, the specific field may include at least one of a HARQ process number, a redundancy version (RV), an MCS, and an FDRA. In a case where the specific field is a specific value, the UE may recognize that the request field is for the A-CSI on PUCCH.

The DCI for triggering the A-CSI on PUCCH may require both the PRI and the request field.

The DL grant in Rel. 16 does not include the request field. Therefore, a DL grant including the request field may be introduced. Both DL and UL grants may be used for A-CSI triggering.

According to Embodiment 2, the UE can properly trigger the A-CSI on PUCCH.

### Embodiment 3

The new DCI field described in at least one of Embodiment 1 and Embodiment 2 may be introduced into the DCI format for at least one of the DL grant and the UL grant.

Similarly to a priority indicator field or invalid symbol pattern indicator field in Rel. 16, whether or not the PRI or A-PRI field exists in the individual DCI format may be set by the RRC parameter. One RRC parameter may indicate whether or not the PRI field exists in all DCI formats for the DL grant and the UL grant. The RRC parameter for each DCI format for the DL grant or the UL grant may indicate whether or not the PRI field exists in the corresponding DCI format.

According to Embodiment 3, the UE can properly decode the PRI for the A-CSI on PUCCH.

In the following Embodiments 4 to 7, at least one of PUCCH resource allocation for the A-CSI on PUCCH and triggering of the A-CSI on PUCCH may be according to at least one of Embodiments 1 to 3.

### Embodiment 4

The DCI that triggers the A-CSI on PUCCH may schedule data or does not have to schedule data. The A-CSI on PUCCH may be triggered by at least one of the following DCI 1, DCI 2, DCI 3, and DCI 4.

<<DCI 1>>

The A-CSI on PUCCH may be triggered by DL DCI that does not schedule DL data (PDSCH). The DCI may be according to at least one of the following DCI 1-1 and DCI 1-2.

[DCI 1-1]

An individual/special operation may be performed for a specific DCI format. The specific DCI format may be at least one of a DCI format 1_1 and a DCI format 1_2.

All or some of the configurable specific fields other than the DCI field indicating the PUCCH resource may be set to 0. The DCI field indicating the PUCCH resource may be the PRI or the A-PRI.

The specific field may be at least one of the TDRA, the FDRA, virtual resource block (VRB)-to-physical resource block (PRB) mapping, a downlink assignment indicator (DAI), a PDSCH-to-HARQ feedback timing indicator, or the RV.

By reducing the size (control channel element (CCE) aggregation level) of triggering DCI, reliability of the triggering DCI can be increased, and resource utilization efficiency can be enhanced.

[DCI 1-2]

A DCI format other than the specific DCI format may be according to the following DCI 1-2-1 and DCI 1-2-2. Further, the specific DCI format may be according to the following DCI 1-2-1 and DCI 1-2-2.

[[DCI 1-2-1]]

The TDRA and the FDRA may be used for PUCCH resource allocation instead of PDSCH resource allocation.

[[DCI 1-2-2]]

The A-PRI or the PRI may indicate the PUCCH resource for the A-CSI on PUCCH. In this case, since the PRI does not need to indicate the PUCCH resource for the HARQ-ACK, the PRI may indicate the PUCCH resource for the A-CSI on PUCCH without adding a new mechanism.

<<DCI 2>>

The A-CSI on PUCCH may be triggered by DL DCI that schedules DL data (PDSCH).

Most fields of the DCI except for the PRI or the A-PRI may be used for PDSCH scheduling. The DCI may be according to the following DCI 2-1 and DCI 2-2.

[DCI 2-1]

In a case where it is necessary to select the PUCCH resource for the A-CSI on PUCCH, the PRI or the A-PRI may be used. The PRI or the A-PRI may be according to the PUCCH resource notification method 2 in Embodiment 1. In a case where the PRI is used for the A-CSI, the PRI does not have to be used for PDSCH scheduling.

[DCI 2-2]

Separately from the existing TDRA and FDRA fields for the PDSCH, new TDRA and FDRA fields for the A-CSI on PUCCH may be introduced.

The new TDRA and FDRA fields may be according to the PUCCH resource notification method 1 in Embodiment 1. The new TDRA and FDRA fields may indicate the PUCCH resource allocation for the A-CSI by the same mechanism as PDSCH scheduling. The PRI may be used for PDSCH scheduling (the PUCCH resource for the HARQ-ACK).

Similarly to the indication method 1 of the PUCCH resource notification method 1 of Embodiment 1, the new TDRA and FDRA fields may be according to the scheduling limitation for the PUCCH format, or there is no scheduling limitation.

<<DCI 3>>

The A-CSI on PUCCH may be triggered by UL DCI that does not schedule UL data (PUSCH). The DCI may be according to at least one of the following DCI 3-1 and DCI 3-2, similarly to the DCI 1 described above.

[DCI 3-1]

An individual/special operation may be performed for a specific DCI format. The specific DCI format may be at least one of a DCI format 0_1 and a DCI format 0_2.

All or some of the configurable specific fields other than the DCI field indicating an A-CSI request may be set to 0. The DCI field indicating the A-CSI request may be the CSI request or the A-CSI request.

The specific field may be at least one of the TDRA, the FDRA, the VRB-to-PRB mapping, the DAI, and the RV.

By reducing the size (control channel element (CCE) aggregation level) of triggering DCI, reliability of the triggering DCI can be increased, and resource utilization efficiency can be enhanced.

[DCI 3-2]

A DCI format other than the specific DCI format may be according to the following DCI 3-2-1 and DCI 3-2-2. Further, the specific DCI format may be according to the following DCI 3-2-1 and DCI 3-2-2.

[[DCI 3-2-1]]

The TDRA and the FDRA may be used for PUCCH resource allocation instead of PUSCH resource allocation.

[[DCI 3-2-2]]

A newly introduced A-PRI or PRI may indicate the PUCCH resource for the A-CSI on PUCCH. In the UL DCI, since the PRI does not need to indicate the PUCCH resource for the HARQ-ACK, the PRI may indicate the PUCCH resource for the A-CSI on PUCCH without adding a new mechanism.

<<DCI 4>>

The A-CSI on PUCCH may be triggered by UL DCI that schedules UL data (PUSCH).

Most fields of the DCI except for the CSI request or the A-CSI request may be used for PUSCH scheduling. The DCI may be according to the following DCI 4-1 and DCI 4-2.

[DCI 4-1]

In a case where it is necessary to select the PUCCH resource for the A-CSI on PUCCH, the PRI or the A-PRI may be used. The PRI or the A-PRI may be according to the PUCCH resource notification method 2 in Embodiment 1. In a case where the PRI is used for the A-CSI, the PRI does not have to be used for PUSCH scheduling.

[DCI 4-2]

Separately from the existing TDRA and FDRA fields for the PUSCH, new TDRA and FDRA fields for the A-CSI on PUCCH may be introduced.

The new TDRA and FDRA fields may be according to the PUCCH resource notification method 1 in Embodiment 1. The new TDRA and FDRA fields may indicate the PUCCH resource allocation for the A-CSI by the same mechanism as PUSCH scheduling. The PRI may be used for PDSCH scheduling (the PUCCH resource for the HARQ-ACK).

Similarly to the indication method 1 of the PUCCH resource notification method 1 of Embodiment 1, the new TDRA and FDRA fields may be according to the scheduling limitation for the PUCCH format, or there is no scheduling limitation.

According to Embodiment 4, it becomes clear whether or not the DCI that triggers the A-CSI on PUCCH schedules data.

### Embodiment 5

Whether or not the DCI that triggers the A-CSI on PUCCH schedules data may be according to any one of the following relationships 1 and 2 between triggering and scheduling.

<<Relationship 1>>

Whether or not the DCI that triggers the A-CSI on PUCCH schedules data may be dynamically switched.

The switching method may be at least one of the following switching methods 1 and 2.

[Switching Method 1]

The switching may be performed by the DCI field. The DCI field may be at least one of the following switching methods 1-1 and 1-2.

[[Switching Method 1-1]]

The DCI may include a UL-shared channel (SCH) indicator field or a DL-SCH indicator field. The UL-SCH indicator field may indicate that the DCI schedules the PUSCH together with the triggering of the A-CSI on PUCCH. The DL-SCH indicator field may indicate that the DCI schedules the PDSCH together with the triggering of the A-CSI on PUCCH. Similarly to the DCI formats 0_1 and 0_2, the UL-SCH indicator field may be newly introduced into the DCI format 0_0. The DL-SCH indicator field may be newly introduced into the DL grant similarly to the DCI formats 1_0, 1_1, and 1_2.

[[Switching Method 1-2]]

A new field that indicates whether or not the DCI triggering the A-CSI on PUCCH schedules data may be introduced. For example, the new field for the UL DCI may be CSI (A-CSI) with the UL-SCH indicator field. For example, the new field for the DL DCI may be CSI (A-CSI) with the DL-SCH indicator field.

[Switching Method 2]

The switching may depend on a rule or a formula. The rule or formula may be defined in the specification. For example, in a case where the size of the A-CSI on PUCCH is greater than x (for example, x bits), the DCI triggering the A-CSI on PUCCH does not schedule data. According to this method, an increase in DCI overhead can be prevented.

<<Relationship 2>>

Whether or not the DCI that triggers the A-CSI on PUCCH schedules data does not have to be dynamically switched.

It may be specified in the specification that the DCI triggering the A-CSI on PUCCH does not schedule data.

For example, the UE does not expect that the A-CSI on PUCCH is triggered by the DCI format x y that schedules the PUSCH/PDSCH. The DCI format x y may include at least one of 0_0, 0_1, 0_2, 1_0, 1_1, and 1_2.

It may be specified in the specification that the DCI triggering the A-CSI on PUCCH schedules data. For example, the UE receives the PDCCH with a configured DCI format x y that schedules the PUSCH/PDSCH and triggers the A-CSI on PUCCH. The DCI format x y may include at least one of 0_0, 0_1, 0_2, 1_0, 1_1, and 1_2.

According to Embodiment 5, the UE can properly recognize whether or not the DCI triggering the A-CSI on PUCCH schedules data.

### Embodiment 6

The A-CSI on PUCCH and the A-CSI on PUSCH may be supported.

The UE may or does not have to support transmission of both the A-CSI on PUCCH and the A-CSI on PUSCH in one period. The period may be any one of a slot, a subslot, or a symbol, or may be an overlapping time resource when a time resource for the A-CSI on PUCCH and a time resource for the A-CSI on PUSCH overlap.

The A-CSI on PUCCH, the A-CSI on PUSCH, the SP-CSI on PUSCH, the SP-CSI on PUCCH, and the P-CSI on PUCCH may be prioritized in this order.

The A-CSI on PUCCH and the A-CSI on PUSCH may be according to any of the following supports 1 to 5.

«Support 1»

In one cell, the A-CSI on PUCCH and the A-CSI on PUSCH may be supported. For example, the UE may transmit both the A-CSI on PUCCH and the A-CSI on PUSCH on a component carrier (CC) #0.

«Support 2»

In each cell, one of the A-CSI on PUCCH and the A-CSI on PUSCH may be supported. For example, the A-CSI on PUCCH may be transmitted on the CC #0, and the A-CSI on PUSCH may be transmitted on a CC #1.

«Support 3»

In each cell group, one of the A-CSI on PUCCH and the A-CSI on PUSCH may be supported. For example, the A-CSI on PUCCH may be transmitted on a cell group (CG) #0, and the A-CSI on PUSCH may be transmitted on a CG #1.

<<Support 4>>

In each frequency range (FR), one of the A-CSI on PUCCH and the A-CSI on PUSCH may be supported. For example, the A-CSI on PUCCH may be transmitted on a FR #x, and the A-CSI on PUSCH may be transmitted on a FR #y.

<<Support 5>>

Transmission of both the A-CSI on PUCCH and the A-CSI on PUSCH in one period does not have to be supported. For example, the UE does not expect to transmit the A-CSI on PUCCH and the A-CSI on PUSCH in one period. For example, the UE does not expect a collision between the A-CSI on PUCCH and the A-CSI on PUSCH.

According to Embodiment 6, the UE can properly process the A-CSI on PUCCH and the A-CSI on PUSCH.

### Embodiment 7

In a case where the A-CSI on PUCCH and the A-CSI on PUSCH collide with each other, the UE may perform one of the following collision processings 1 and 2.

<<Collision Processing 1>>

In a case where the A-CSI on PUCCH and the A-CSI on PUSCH collide with each other, one of them may pre-empt the other (the UE may preferentially transmit one over the other). The collision processing 1 may be according to any of the following collision processings 1-1 to 1-3.

[Collision Processing 1-1]

The A-CSI on PUCCH may always pre-empt the A-CSI on PUSCH. In other words, the A-CSI on PUCCH may always be prioritized over the A-CSI on PUSCH.

[Collision Processing 1-2]

The A-CSI on PUSCH may always pre-empt the A-CSI on PUCCH. In other words, the A-CSI on PUSCH may always be prioritized over the A-CSI on PUCCH.

[Collision Processing 1-3]

The A-CSI with higher priority may pre-empt the A-CSI with lower priority. In other words, the A-CSI with higher priority may be prioritized over the A-CSI with lower priority. The collision processing 1-3 may be according to at least one of the following collision processings 1-3-1 to 1-3-3.

[[Collision Processing 1-3-1]]

The priority of the A-CSI may be determined according to a rule or a formula. The rule or formula may be defined in the specification. For example, the A-CSI on PUCCH, the A-CSI on PUSCH, the SP-CSI on PUSCH, the SP-CSI on PUCCH, and the P-CSI on PUCCH may be prioritized in this order. The priority may be used to determine a power control for CSI report transmission across cell groups for a given UE.

[[Collision Processing 1-3-2]]

The priority may be indicated by the DCI. For example, the priority may be indicated by a priority indicator in the DCI that triggers the A-CSI.

[[Collision Processing 1-3-3]]

The priority may be set by the RRC parameter.

<<Collision Processing 2>>

In a case where the A-CSI on PUCCH and the A-CSI on PUSCH collide with each other, they may be multiplexed (the UE may multiplex the A-CSI on PUCCH and the A-CSI on PUSCH). The collision processing 2 may be according to any of the following collision processings 2-1 to 2-3.

[Collision Processing 2-1]

One of the A-CSI on PUCCH and the A-CSI on PUSCH may be punctured. The collision processing 2-1 may be according to any of the following collision processings 2-1-1 and 2-1-2.

[[Collision Processing 2-1]]

First, the UE maps the A-CSI on PUSCH to the PUSCH resource. Thereafter, the UE maps the A-CSI on PUCCH to a resource for the A-CSI on PUCCH in the PUSCH resource (the UE replaces the A-CSI on PUSCH in the resource for the A-CSI on PUCCH with the A-CSI on PUCCH). In other words, the A-CSI on PUCCH pre-empts the A-CSI on PUSCH (the A-CSI on PUCCH is prioritized over the A-CSI on PUSCH).

[[Collision Processing 2-1-2]]

First, the UE maps the A-CSI on PUCCH to the PUCCH resource. Thereafter, the UE maps the A-CSI on PUSCH to a resource for the A-CSI on PUSCH in the PUCCH resource (the UE replaces the A-CSI on PUCCH in the resource for the A-CSI on PUSCH with the A-CSI on PUSCH). In other words, the A-CSI on PUSCH pre-empts the A-CSI on PUCCH (the A-CSI on PUSCH is prioritized over the A-CSI on PUCCH).

One of the collision processings 2-1-1 and 2-1-2 that is to be used may be selected based on a rule. The rule may be defined in the specification. For example, in a case where it is defined as a rule that the A-CSI on PUCCH, the A-CSI on PUSCH, the SP-CSI on PUSCH, the SP-CSI on PUCCH, and the P-CSI on PUCCH are prioritized in this order, the A-CSI on PUCCH is prioritized over the A-CSI on PUSCH, and thus, the collision processing 2-1-1 may be used.

[Collision Processing 2-2]

One of the A-CSI on PUCCH and the A-CSI on PUSCH may be rate-matched. The collision processing 2-2 may be according to any of the following collision processings 2-2-1 and 2-2-2.

[[Collision Processing 2-2-1]]

The UE maps the A-CSI on PUCCH to the PUCCH resource. In addition, the UE maps the A-CSI on PUSCH to the remaining resource of the PUCCH resource in the PUSCH resource. In other words, the A-CSI on PUCCH pre-empts the A-CSI on PUSCH (the A-CSI on PUCCH is prioritized over the A-CSI on PUSCH).

[[Collision Processing 2-2-2]]

The UE maps the A-CSI on PUSCH to the PUSCH resource. In addition, the UE maps the A-CSI on PUCCH to the remaining resource of the PUSCH resource in the PUCCH resource. In other words, the A-CSI on PUSCH pre-empts the A-CSI on PUCCH (the A-CSI on PUSCH is prioritized over the A-CSI on PUCCH).

One of the collision processings 2-2-1 and 2-2-2 that is to be used may be selected based on a rule. The rule may be defined in the specification. For example, in a case where it is defined as a rule that the A-CSI on PUCCH, the A-CSI on PUSCH, the SP-CSI on PUSCH, the SP-CSI on PUCCH, and the P-CSI on PUCCH are prioritized in this order, the A-CSI on PUCCH is prioritized over the A-CSI on PUSCH, and thus, the collision processing 2-2-1 may be used.

[Collision Processing 2-3]

The collision processing 2-1 (puncturing) and the collision processing 2-2 (rate matching) may depend on the size of the A-CSI. The UE may determine which of the collision processing 2-1 and the collision processing 2-2 to apply based on at least one of the size of the A-CSI on PUCCH or the size of the A-CSI on PUSCH. The UE may determine which of the collision processing 2-1 and collision processing 2-2 to apply by comparing at least one of the size of the A-CSI on PUCCH and the size of the A-CSI on PUSCH with a threshold.

According to Embodiment 7, even in a case where the A-CSI on PUCCH and the A-CSI on PUSCH collide with each other, the UE can appropriately process the A-CSI on PUCCH and the A-CSI on PUSCH.

(Radio Communication System)

Hereinafter, a configuration of a radio communication system according to an embodiment of the present disclosure will be described. In this radio communication system, communication is performed using one or a combination of the radio communication methods according to the embodiments of the present disclosure.

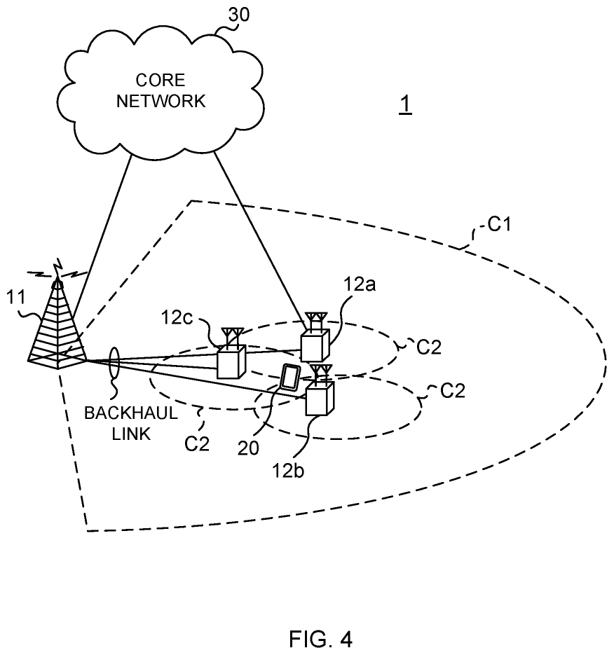

FIG. 4 is a diagram illustrating an example of a schematic configuration of the radio communication system according to an embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (Evolved Universal Terrestrial Radio Access (E-UTRA)) and NR (E-UTRA-NR Dual Connectivity (EN-DC)), dual connectivity between NR and LTE (NR-E-UTRA Dual Connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is an MN, and an LTE (E-UTRA) base station (eNB) is an SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be located in at least one cell. The arrangement, number, and the like of cells and the user terminals 20 are not limited to the aspects illustrated in the drawings. The base stations 11 and 12 will be collectively referred to as base stations 10 unless these base stations are distinguished from each other.

The user terminal 20 may be connected to at least one of the plurality of base stations 10. The user terminal 20 may use at least one of carrier aggregation (CA) and dual connectivity (DC) using a plurality of component carriers (CC).

Each CC may be included in at least one of a first frequency range 1 (FR1) and a second frequency range 2 (FR2). The macro cell C1 may be included in the FR1, and the small cell C2 may be included in the FR2. For example, the FR1 may be a frequency range of 6 GHz or less (sub-6 GHz), and the FR2 may be a frequency range higher than 24 GHz (above-24 GHz). Note that the frequency ranges, definitions, and the like of the FR1 and the FR2 are not limited thereto, and, for example, the FR1 may correspond to a frequency range higher than the FR2.

Further, the user terminal 20 may perform communication on each CC using at least one of time division duplex (TDD) and frequency division duplex (FDD).

The plurality of base stations 10 may be connected by wire (for example, an optical fiber or an X2 interface in compliance with common public radio interface (CPRI)) or wirelessly (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), a next generation core (NGC), and the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, a physical downlink shared channel (PDSCH) shared by the respective user terminals 20, a physical broadcast channel (PBCH), a physical downlink control channel (PDCCH), and the like may be used as downlink channels.

Further, a physical uplink shared channel (PUSCH) shared by the respective user terminals 20, a physical uplink control channel (PUCCH), a physical random access channel (PRACH), and the like may be used as uplink channels in the radio communication system 1.

User data, higher layer control information, and a system information block (SIB) and the like are transmitted on the PDSCH. User data, higher layer control information, and the like may be transmitted on the PUSCH. Further, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

Note that the DCI that schedules the PDSCH may be referred to as DL assignment, DL DCI, or the like, and the DCI that schedules the PUSCH may be referred to as a UL grant, UL DCI, or the like. Note that the PDSCH may be replaced with DL data, and the PUSCH may be replaced with UL data.

A control resource set (CORESET) and a search space may be used to detect the PDCCH. The CORESET corresponds to a resource that searches for the DCI. The search space corresponds to a search area and a search method for PDCCH candidates. One CORESET may be associated with one or more search spaces. The UE may monitor the CORESET associated with a given search space based on search space configuration.

One search space may correspond to a PDCCH candidate corresponding to one or more aggregation levels. One or more search spaces may be referred to as a search space set. Note that the terms “search space”, “search space set”, “search space configuration”, “search space set configuration”, “CORESET”, “CORESET configuration”, and the like in the present disclosure may be interchangeable.

Uplink control information (UCI) including at least one of channel state information (CSI), delivery confirmation information (which may be referred to as, for example, hybrid automatic repeat request acknowledgement (HARQ-ACK), ACK/NACK, and the like), scheduling request (SR), or the like may be transmitted on the PUCCH. A random access preamble for establishing a connection with a cell may be transmitted on the PRACH.

Note that in the present disclosure, downlink, uplink, and the like may be expressed without “link”. Further, various channels may be expressed without adding “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS Block (SSB), and the like. Note that the SS, the SSB, or the like may also be referred to as a reference signal.

Further, in the radio communication system 1, a sounding reference signal (SRS), a demodulation reference signal (DMRS), and the like may be transmitted as an uplink reference signal (UL-RS). Note that the DMRS may be referred to as a “UE specific reference signal”.

(Base Station)

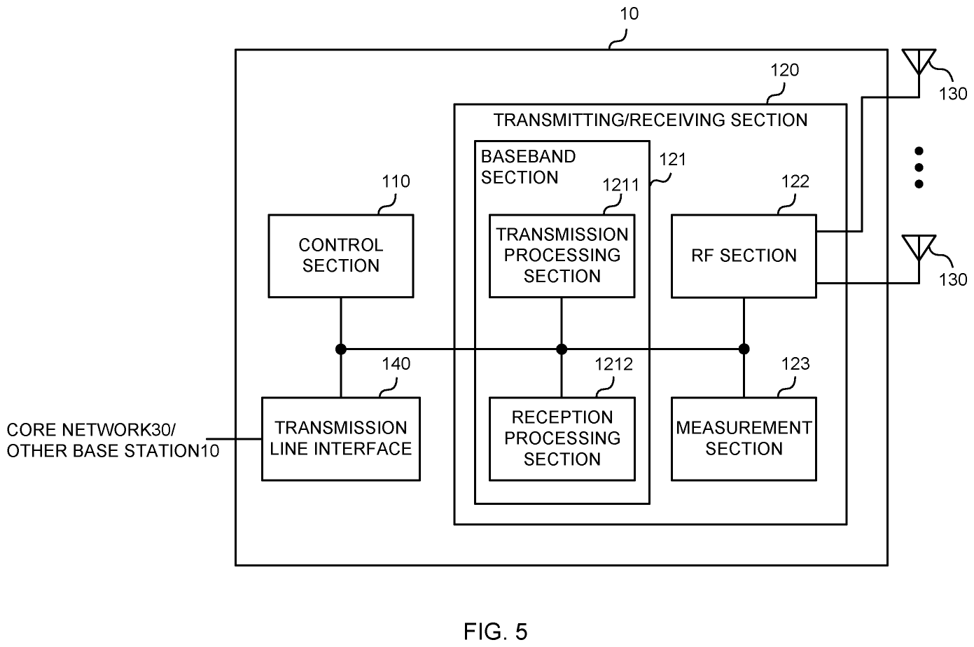

FIG. 5 is a diagram illustrating an example of a configuration of the base station according to an embodiment. The base station 10 includes a control section 110, a transmission/reception section 120, a transmission/reception antenna 130, and a transmission line interface 140. Note that one or more control sections 110, one or more transmission/reception sections 120, one or more transmission/reception antennas 130, and one or more transmission line interfaces 140 may be included.

Note that this example mainly describes functional blocks of characteristic parts in the present embodiment, and it may be assumed that the base station 10 also includes other functional blocks necessary for radio communication. A part of processing of each section described below may be omitted.

The control section 110 controls the entire base station 10. The control section 110 can be implemented by a controller, a control circuit, and the like, which are described based on common recognition in the technical field related to the present disclosure.

The control section 110 may control signal generation, scheduling (for example, resource assignment and mapping), and the like. The control section 110 may control transmission/reception, measurement, and the like using the transmission/reception section 120, the transmission/reception antenna 130, and the transmission line interface 140. The control section 110 may generate data to be transmitted as a signal, control information, a sequence, and the like, and may forward the data, the control information, the sequence, and the like to the transmission/reception section 120. The control section 110 may perform call processing (such as configuration or release) of a communication channel, management of the state of the base station 10, and management of a radio resource.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can be implemented by a transmitter/receiver, an RF circuit, a baseband circuit, a filter, a phase shifter, a measurement circuit, a transmission/reception circuit, and the like, which are described based on common recognition in the technical field related to the present disclosure.

The transmission/reception section 120 may be configured as an integrated transmission/reception section, or may include a transmission section and a reception section. The transmission section may include the transmission processing section 1211 and the RF section 122. The reception section may include the reception processing section 1212, the RF section 122, and the measurement section 123.

The transmission/reception antenna 130 can be implemented by an antenna described based on common recognition in the technical field related to the present disclosure, for example, an array antenna.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a transmission beam and a reception beam by using digital beam forming (for example, precoding), analog beam forming (for example, phase rotation), and the like.

The transmission/reception section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on data, control information, and the like acquired from the control section 110 to generate a bit string to be transmitted.

The transmission/reception section 120 (transmission processing section 1211) may perform transmission processing such as channel encoding (which may include error correction encoding), modulation, mapping, filter processing, discrete Fourier transform (DFT) processing (if necessary), inverse fast Fourier transform (IFFT) processing, precoding, digital-analog conversion, and the like on a bit string to be transmitted, and output a baseband signal.

The transmission/reception section 120 (RF section 122) may perform modulation to a radio frequency band, filter processing, amplification, and the like on the baseband signal, and may transmit a signal in the radio frequency band via the transmission/reception antenna 130.

Meanwhile, the transmission/reception section 120 (RF section 122) may perform amplification, filter processing, demodulation to a baseband signal, and the like on the signal in the radio frequency band received via the transmission/reception antenna 130.

The transmission/reception section 120 (reception processing section 1212) may apply reception processing such as analog-digital conversion, fast Fourier transform (FFT) processing, inverse discrete Fourier transform (IDFT) processing (if necessary), filter processing, demapping, demodulation, decoding (which may include error correction decoding), MAC layer processing, RLC layer processing, PDCP layer processing, and the like on the acquired baseband signal, and acquire user data and the like.

The transmission/reception section 120 (measurement section 123) may measure a received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), or a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit, and the like user data (user plane data), control plane data, and the like for the user terminal 20.

Note that the transmission section and the reception section of the base station 10 in the present disclosure may include at least one of the transmission/reception section 120, the transmission/reception antenna 130, and the transmission line interface 140.

The transmission/reception section 120 may transmit information on the physical uplink control channel (PUCCH) resource by at least one of the downlink control information (DCI) and the radio resource control information element (RRC-IE). The transmission/reception section 120 may receive a report of the aperiodic channel state information (A-CSI) using the PUCCH resource.

The transmission/reception section 120 may transmit the downlink control information that does not schedule data. The transmission/reception section 120 may receive a report of the aperiodic channel state information (A-CSI) triggered by the downlink control information on the physical uplink control channel (PUCCH).

(User Terminal)

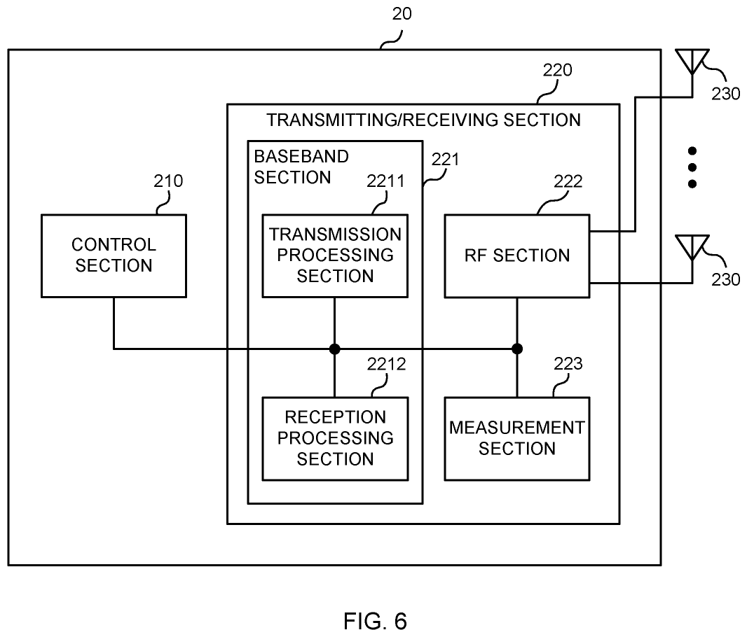

FIG. 6 is a diagram illustrating an example of a configuration of the user terminal according to an embodiment. The user terminal 20 includes a control section 210, a transmission/reception section 220, and a transmission/reception antenna 230. Note that one or more control sections 210, one or more transmission/reception sections 220, and one or more transmission/reception antennas 230 may be included.

Note that this example mainly describes functional blocks of characteristic parts in the present embodiment, and it may be assumed that the user terminal 20 also includes other functional blocks necessary for radio communication. A part of processing of each section described below may be omitted.

The control section 210 controls the entire user terminal 20. The control section 210 can be implemented by a controller, a control circuit, and the like, which are described based on common recognition in the technical field related to the present disclosure.

The control section 210 may control signal generation, mapping, and the like. The control section 210 may control transmission/reception, measurement, and the like using the transmission/reception section 220 and the transmission/reception antenna 230. The control section 210 may generate data to be transmitted as a signal, control information, a sequence, and the like, and may forward the data, the control information, the sequence, and the like to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can be implemented by a transmitter/receiver, an RF circuit, a baseband circuit, a filter, a phase shifter, a measurement circuit, a transmission/reception circuit, and the like, which are described based on common recognition in the technical field related to the present disclosure.

The transmission/reception section 220 may be implemented as an integrated transmission/reception section, or may include a transmission section and a reception section. The transmission section may include the transmission processing section 2211 and the RF section 222. The reception section may include the reception processing section 2212, the RF section 222, and the measurement section 223.

The transmission/reception antenna 230 can be implemented by an antenna described based on common recognition in the technical field related to the present disclosure, for example, an array antenna.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a transmission beam and a reception beam by using digital beam forming (for example, precoding), analog beam forming (for example, phase rotation), and the like.

The transmission/reception section 220 (transmission processing section 2211) may perform PDCP layer processing, RLC layer processing (for example, RLC retransmission control), MAC layer processing (for example, HARQ retransmission control), and the like, for example, on data or control information acquired from the control section 210 to generate a bit string to be transmitted.

The transmission/reception section 220 (transmission processing section 2211) may perform transmission processing such as channel encoding (which may include error correction encoding), modulation, mapping, filtering processing, DFT processing (if necessary), IFFT processing, precoding, and digital-analog conversion on a bit string to be transmitted, and may output a baseband signal.

Note that whether or not to apply DFT processing may be determined based on configuration of transform precoding. When transform precoding is enabled for a given channel (for example, the PUSCH), the transmission/reception section 220 (transmission processing section 2211) may perform the DFT processing as the above-described transmission processing in order to transmit the channel by using a DFT-s-OFDM waveform. If not, the transmission/reception section 220 (transmission processing section 2211) is not required to perform the DFT processing as the above-described transmission processing.

The transmission/reception section 220 (RF section 222) may perform modulation to a radio frequency band, filtering processing, amplification, and the like on a baseband signal, and may transmit the signal in the radio frequency band via the transmission/reception antenna 230.

Meanwhile, the transmission/reception section 220 (RF section 222) may perform amplification, filtering processing, demodulation to a baseband signal, and the like on the signal in the radio frequency band received via the transmission/reception antenna 230.

The transmission/reception section 220 (reception processing section 2212) may acquire user data and the like by applying reception processing such as analog-digital conversion, FFT processing, IDFT processing (if necessary), filter processing, demapping, demodulation, decoding (which may include error correction decoding), MAC layer processing, RLC layer processing, and PDCP layer processing on the acquired baseband signal.

The transmission/reception section 220 (measurement section 223) may measure the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmission section and the reception section of the user terminal 20 in the present disclosure may include at least one of the transmission/reception section 220 and the transmission/reception antenna 230.

The transmission/reception section 220 may receive information on the physical uplink control channel (PUCCH) resource by at least one of the downlink control information (DCI) and the radio resource control information element (RRC-IE). The control section 210 may report the aperiodic channel state information (A-CSI) by using the PUCCH resource.

The downlink control information may have the downlink control information format for scheduling the uplink shared channel or the downlink shared channel.

The radio resource control information element may include configuration of one or more PUCCH resources per bandwidth part (BWP).

The reporting may be triggered by a specific field in the downlink control information.

The transmission/reception section 220 may receive the downlink control information that does not schedule data. The control section 210 may report the aperiodic channel state information (A-CSI) triggered by the downlink control information on the physical uplink control channel (PUCCH).

The transmission/reception section 220 may receive the downlink control information that schedules data. The control section 210 may report the aperiodic channel state information (A-CSI) triggered by the downlink control information on the physical uplink control channel (PUCCH).

A time resource for the reporting of the A-CSI on the PUCCH may overlap with a time resource for the reporting of the aperiodic channel state information (A-CSI) on the physical uplink shared channel (PUSCH).

The control section 210 may give priority to one of the A-CSI on the PUSCH and the A-CSI on the PUCCH, and may perform at least one of dropping, puncturing, and rate matching of the other A-CSI.

(Hardware Configuration)

Note that the block diagrams that have been used to describe the above embodiments illustrate blocks in functional units. These functional blocks (components) may be implemented in arbitrary combinations of at least one of hardware and software. Further, the method for implementing each functional block is not particularly limited. That is, each functional block may be implemented by a single apparatus physically or logically aggregated, or may be implemented by directly or indirectly connecting two or more physically or logically separate apparatuses (using wire, wireless, or the like, for example) and using the plurality of apparatuses. The functional blocks may be implemented by combining software with the above-described single apparatus or the above-described plurality of apparatuses.

Here, the functions include, but are not limited to, determining, judging, computing, calculating, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning. For example, a functional block (component) that functions to perform transmission may be referred to as a transmitting unit, a transmitter, and the like. In any case, as described above, the implementation method is not particularly limited.

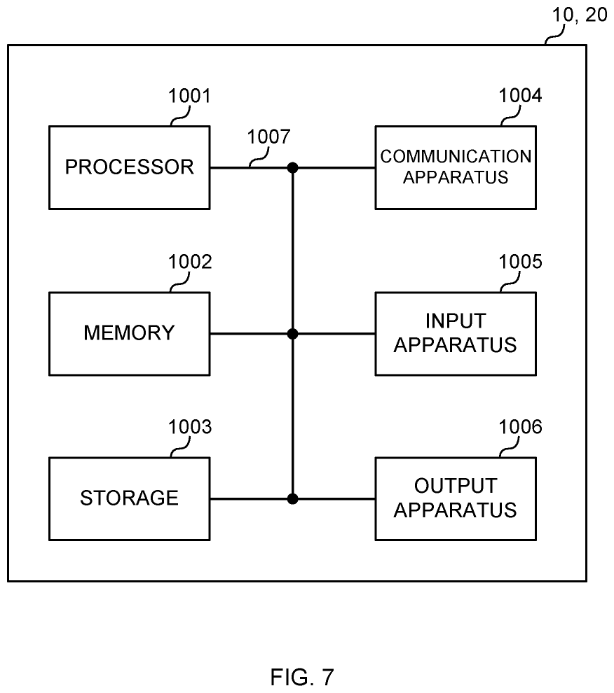

For example, the base station, the user terminal, and the like according to an embodiment of the present disclosure may function as a computer that performs the processing of the radio communication method of the present disclosure. FIG. 7 is a diagram illustrating an example of the hardware configuration of the base station and the user terminal according to an embodiment. Physically, the above-described base station 10 and user terminal 20 may be implemented as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit are interchangeable. The hardware configuration of the base station 10 and the user terminal 20 may include one or more apparatuses illustrated in the drawings, or does not have to include some apparatuses.

For example, although only one processor 1001 is illustrated, a plurality of processors may be provided. Further, the processing may be performed by one processor, or the processing may be performed by two or more processors simultaneously, sequentially, or by using other different methods. Note that the processor 1001 may be implemented by one or more chips.

Each of the functions of the base station 10 and the user terminal 20 is implemented by causing predetermined software (program) to be read on hardware such as the processor 1001 or the memory 1002, thereby causing the processor 1001 to perform operation, controlling communication via the communication apparatus 1004, and controlling at least one of reading and writing of data from or in the memory 1002 and the storage 1003.

The processor 1001 may control the whole computer by, for example, running an operating system. The processor 1001 may be configured by a central processing unit (CPU) including an interface with peripheral equipment, a control apparatus, an operation apparatus, a register, and the like. For example, at least a part of the above-described control section 110 (210), transmission/reception section 120 (220), and the like may be implemented by the processor 1001.

Further, the processor 1001 reads a program (program code), a software module, data, and the like from at least one of the storage 1003 and the communication apparatus 1004 into the memory 1002, and performs various types of processing according to them. As the program, a program to cause a computer to perform at least a part of the operation described in the above-described embodiment is used. For example, the control section 110 (210) may be implemented by a control program that is stored in the memory 1002 and is operated in the processor 1001, and other functional blocks may be implemented similarly.

The memory 1002 is a computer-readable recording medium, and may be implemented by, for example, at least one of a read only memory (ROM), an erasable programmable ROM (EPROM), an electrically EPROM (EEPROM), a random access memory (RAM), and/or other appropriate storage media. The memory 1002 may be referred to as a “register”, a “cache”, a “main memory (primary storage apparatus)”, and the like. The memory 1002 can store a program (program code), a software module, and the like, which are executable for implementing the radio communication method according to an embodiment of the present disclosure.

The storage 1003 is a computer-readable recording medium, and may be implemented by, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, a key drive), a magnetic stripe, a database, a server, and other appropriate storage media. The storage 1003 may be referred to as an auxiliary storage device.

The communication apparatus 1004 is hardware (transmission/reception device) for performing inter-computer communication via at least one of a wired network and a radio network, and is referred to as, for example, a network device, a network controller, a network card, and a communication module. The communication apparatus 1004 may include a high frequency switch, a duplexer, a filter, a frequency synthesizer, and the like in order to implement, for example, at least one of frequency division duplex (FDD) and time division duplex (TDD). For example, the transmission/reception section 120 (220), the transmission/reception antenna 130 (230), and the like described above may be implemented by the communication apparatus 1004. The transmission/reception section 120 (220) may be implemented by a transmission section 120a (220a) and a reception section 120b (220b) physically or logically separated from each other.

The input apparatus 1005 is an input device that receives an input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, and the like). Note that the input apparatus 1005 and the output apparatus 1006 may be provided in an integrated structure (for example, a touch panel).

Further, the respective apparatuses such as the processor 1001 and the memory 1002, are connected by the bus 1007 to communicate information. The bus 1007 may be formed by using a single bus, or may be formed by using different buses for respective connections between apparatuses.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented by using at least one of these pieces of hardware.

### MODIFIED EXAMPLE

Note that the terms used in the present disclosure and the terms that are necessary for understanding of the present disclosure may be replaced with other terms that have the same or similar meanings. For example, a channel, a symbol, and a signal (or signaling) may be interchangeable. Further, the signal may be a message. A reference signal can be abbreviated as an “RS”, and may be referred to as a “pilot”, a “pilot signal”, and the like, depending on which standard applies. Furthermore, a component carrier (CC) may be referred to as a cell, a frequency carrier, a carrier frequency, and the like.

A radio frame may include one or more periods (frames) in a time domain. Each of the one or more periods (frames) constituting the radio frame may be referred to as a “subframe”. Furthermore, the subframe may include one or more slots in the time domain. The subframe may be a fixed time duration (for example, 1 ms) that is not dependent on numerology.

Here, the numerology may be a communication parameter used for at least one of transmission and reception of a given signal or channel. The numerology may indicate at least one of, for example, a subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, and a specific windowing processing performed by the transceiver in a time domain.

The slot may include one or more symbols (for example, orthogonal frequency division multiplexing (OFDM) symbol and single carrier frequency division multiple access (SC-FDMA) symbol) in the time domain. Further, the slot may be a time unit based on the numerology.

The slot may include a plurality of mini slots. Each mini slot may include one or more symbols in the time domain. Further, the mini slot may be referred to as a subslot. Each mini slot may include fewer symbols than the slot. The PDSCH (or PUSCH) transmitted in a time unit larger than the mini slot may be referred to as PDSCH (PUSCH) mapping type A. The PDSCH (or PUSCH) transmitted using the mini slot may be referred to as PDSCH (PUSCH) mapping type B.

The radio frame, the subframe, the slot, the mini slot, and the symbol all represent the time unit in signal transmission. The radio frame, the subframe, the slot, the mini slot, and the symbol may be called by other applicable names, respectively. Note that time units such as the frame, the subframe, the slot, the mini slot, and the symbol in the present disclosure may be interchangeable.

For example, one subframe may be referred to as TTI. A plurality of consecutive subframes may be referred to as TTI. One slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. Note that a unit that represents the TTI may be referred to as the slot, the mini slot, and the like, instead of the subframe.

Here, the TTI refers to the minimum time unit of scheduling in radio communication, for example. For example, in the LTE system, the base station performs scheduling to assign radio resources (a frequency bandwidth and transmission power that can be used in each user terminal and the like) to each user terminal in TTI units. Note that the definition of the TTI is not limited thereto.

The TTI may be a transmission time unit of channel-encoded data packets (transport blocks), code blocks, codewords, or the like, or may be a processing unit in scheduling, link adaptation, or the like. Note that, when the TTI is given, a time interval (for example, the number of symbols) to which the transport block, code block, codeword, or the like is actually mapped may be shorter than the TTI.

Note that, when one slot or one mini slot is referred to as the TTI, one or more TTIs (that is, one or more slots or one or more mini slots) may be the minimum time unit of scheduling. Further, the number of slots (the number of mini slots) constituting the minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, and the like. A TTI that is shorter than the usual TTI may be referred to as a shortened TTI, a short TTI, a partial TTI (or fractional TTI), a shortened subframe, a short subframe, a mini slot, a subslot, a slot, and the like.

Note that a long TTI (for example, a normal TTI, a subframe, or the like) may be interchangeable with a TTI having a time duration exceeding 1 ms, and a short TTI (for example, a shortened TTI) may be interchangeable with a TTI having a TTI duration less than the TTI duration of the long TTI and not less than 1 ms.

The resource block (RB) is the unit of resource assignment in the time domain and the frequency domain, and may include one or more consecutive subcarriers in the frequency domain. The number of subcarriers included in the RB may be the same regardless of the numerology, and may be twelve, for example. The number of subcarriers included in the RB may be determined based on the numerology.

Further, the RB may include one or more symbols in the time domain, and may have a length of one slot, one mini slot, one subframe, or one TTI. One TTI, one subframe, and the like may each include one or more resource blocks.

Note that one or more RBs may be referred to as a physical resource block (PRB (Physical RB)), a subcarrier group (SCG (Sub-Carrier Group)), a resource element group (REG), a PRB pair, an RB pair, or the like.

Furthermore, a resource block may include one or more resource elements (REs). For example, one RE may be a radio resource field of one subcarrier and one symbol.

The bandwidth part (BWP) (which may also be referred to as a partial bandwidth or the like) may represent a subset of consecutive common resource blocks (RBs) for given numerology in a given carrier. Here, the common RB may be specified by the index of the RB based on a common reference point of the carrier. The PRB may be defined in a given BWP and be numbered within the BWP.

The BWP may include a BWP for UL (UL BWP) and a BWP for DL (DL BWP). For the UE, one or more BWPs may be configured within one carrier.

At least one of the configured BWPs may be active, and it does not have to be assumed that the UE transmits and receives a given signal/channel outside the active BWP. Note that a “cell”, a “carrier”, and the like in the present disclosure may be interchangeable with the “BWP”.

Note that the structures of the above-described radio frame, subframe, slot, mini slot, symbol, and the like are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol duration, the length of cyclic prefix (CP), and the like can be variously changed.

Further, the information, parameters, and the like described in the present disclosure may be represented using absolute values or relative values with respect to given values, or may be represented using other corresponding information. For example, the radio resource may be specified by a given index.

The names used for parameters and the like in the present disclosure are in no respect limitative. Furthermore, any mathematical expression or the like that uses these parameters may differ from those explicitly disclosed in the present disclosure. Various channels (PUCCH, PDCCH, and the like) and information elements can be identified by any suitable names. Therefore, various names allocated to these various channels and information elements are in no respect limitative.

The information, a signal, and the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or an arbitrary combination thereof.

Further, information, a signal, and the like can be output in at least one of a direction from a higher layer to a lower layer and a direction from a lower layer to a higher layer. Information, a signal, and the like may be input/output via a plurality of network nodes.

The input and/or output information, signal, and the like can be stored in a specific location (for example, a memory) or can be managed using a management table. The information, signal, and the like to be input and/or output can be overwritten, updated, or appended. The output information, signal, and the like may be deleted. The input information, signal, and the like may be transmitted to another apparatus.

Notification of information may be performed not only by using the aspects/embodiments described in the present disclosure but also using another method. For example, the notification of information in the present disclosure may be performed using physical layer signaling (e.g., downlink control information (DCI), uplink control information (UCI), higher layer signaling (e.g., radio resource control (RRC) signaling, broadcast information (master information block (MIB), system information block (SIB), or the like), medium access control (MAC) signaling, another signal, or a combination thereof.

Note that physical layer signaling may be referred to as Layer 1/Layer 2 (L1/L2) control information (Ll/L2 control signals), L1 control information (L1 control signal), or the like. Further, the RRC signaling may be referred to as an RRC message, and may be, for example, an RRC connection setup message, an RRC connection reconfiguration message, and the like. Further, notification of MAC signaling may be performed using, for example, a MAC control element (MAC CE).

Further, notification of given information (e.g., notification of “being X”) is not limited to explicit notification but may be performed implicitly (for example, by not performing notification of the given information or by performing notification of another piece of information).

Judging may be performed using values represented by one bit (0 or 1), may be performed using Boolean values represented by true or false, or may be performed by comparing numerical values (for example, comparison with a given value).

Regardless of whether software is referred to as software, firmware, middleware, microcode, or hardware description language, or referred to as other names, this should be interpreted broadly, to mean an instruction, an instruction set, a code, a code segment, a program code, a program, a subprogram, a software module, an application, a software application, a software package, a routine, a subroutine, an object, an executable file, an execution thread, a procedure, a function, and the like.

Further, software, instruction, information, and the like may be transmitted/received via a transmission medium. For example, when software is transmitted from a website, a server, or other remote sources by using at least one of wired technology (a coaxial cable, an optical fiber cable, a twisted-pair cable, a digital subscriber line (DSL), and the like) and wireless technology (infrared light, microwaves, and the like), at least one of the wired technology and the wireless technology is included in the definition of the transmission medium.

The terms “system” and “network” used in the present disclosure can be used interchangeably. The “network” may mean an apparatus (for example, the base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, the terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier” can be used interchangeably. The base station may be referred to as a term such as a macro cell, a small cell, a femto cell, or a pico cell.

The base station can accommodate one or more (for example, three) cells. When the base station accommodates a plurality of cells, the entire coverage area of the base station can be partitioned into a plurality of smaller areas, and each smaller area can provide communication service through base station subsystems (e.g., indoor small base stations (remote radio heads (RRHs))). The term “cell” or “sector” refers to a part or the whole of a coverage area of at least one of a base station and a base station subsystem that perform a communication service in this coverage.

In the present disclosure, the terms such as “mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms.

At least one of the base station and the mobile station may be referred to as a transmission apparatus, a reception apparatus, a radio communication apparatus, and the like. Note that at least one of the base station and the mobile station may be a device mounted on a moving object, a moving object itself, and the like. The moving object may be a transportation (for example, a car, an airplane and the like), an unmanned moving object (for example, a drone, an autonomous car, and the like), or a (manned or unmanned) robot. Note that at least one of the base station and the mobile station also includes an apparatus that does not necessarily move during a communication operation. For example, at least one of the base station and the mobile station may be an Internet of Things (IoT) device such as a sensor.

Further, the base station in the present disclosure may be interchangeable with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In the case, the user terminal 20 may have the function of the above-described base station 10. In addition, terms such as “uplink” and “downlink” may be interchangeable with terms corresponding to communication between terminals (for example, “side”). For example, the uplink channel, the downlink channel, and the like may be interchangeable with a side channel.

Similarly, the user terminal in the present disclosure may be interchangeable with the base station. In this case, the base station 10 may have the above-described functions of the user terminal 20.

In the present disclosure, the operation performed by the base station may be performed by an upper node thereof in some cases. In a network including one or more network nodes with base stations, it is clear that various operations performed for communication with a terminal can be performed by a base station, one or more network nodes (examples of which include but are not limited to a mobility management entity (MME) and a serving-gateway (S-GW)) other than the base station, or a combination thereof.

Each aspect/embodiment described in the present disclosure may be used alone, used in combination, or switched in association with execution. Further, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined (for example, a combination of LTE or LTE-A and 5G) and applied.

The phrase “based on” used in the present disclosure does not mean “based only on”, unless otherwise specified. In other words, the phrase “based on” means both “based only on” and “based at least on”.

Any reference to elements with designations such as “first”, “second”, and the like used in the present disclosure does not generally limit the amount or order of these elements. These designations can be used in the present disclosure, as a convenient way of distinguishing between two or more elements. Therefore, reference to the first and second elements does not mean that only two elements are adoptable, or that the first element must precede the second element in some way.

The term “determining” used in the present disclosure may encompass a wide variety of operations. For example, “determining” may be regarded as judging, calculating, computing, processing, deriving, investigating, looking up, search, inquiry (for example, looking up in a table, database, or another data structure), ascertaining, and the like.

Furthermore, “determining” may be regarded as “determining” of receiving (for example, receiving of information), transmitting (for example, transmitting of information), input, output, accessing (for example, accessing to data in a memory), and the like.

Further, “determining” may be regarded as “determining” of resolving, selecting, choosing, establishing, comparing, and the like. In other words, “determining” may be regarded as “determining” of an operation.

Further, “determining” may be interchangeable with “assuming”, “expecting”, “considering”, and the like.

The term “maximum transmission power” described in the present disclosure may mean the maximum value of transmission power, the nominal UE maximum transmit power, or the rated UE maximum transmit power.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interchangeable with “access”.

In the present disclosure, when two elements are connected, these elements may be considered to be “connected” or “coupled” to each other by using one or more electrical wires, cables, printed electrical connections, and the like, and by using, as some non-limiting and non-inclusive examples, electromagnetic energy having a wavelength in the radio frequency domain, microwave domain, and optical (both visible and invisible) domain, and the like.

In the present disclosure, the phrase “A and B are different” may mean “A and B are different from each other”. Note that the phrase may mean that “A and B are different from C”. The terms such as “leave”, “coupled”, and the like may be interpreted as “different”.

When the terms “include”, “including”, and variations thereof are used in the present disclosure, these terms are intended to be inclusive similarly to the term “comprising”. Furthermore, the term “or” used in the present disclosure is intended not to be exclusive-OR.

In the present disclosure, when English articles such as “a”, “an”, and “the” are added in translation, the present disclosure may include the plural forms of nouns that follow these articles.

Although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Therefore, the description in the present disclosure is provided for the purpose of describing examples, and thus, should by no means be construed to limit the invention according to the present disclosure in any way.

1. A terminal comprising:
a reception section that receives information on a physical uplink control channel (PUCCH) resource by at least one of downlink control information and a radio resource control information element; and
a control section that reports aperiodic channel state information (A-CSI) by using the PUCCH resource.

2. The terminal according to claim 1, wherein the downlink control information has a downlink control information format for scheduling an uplink shared channel or a downlink shared channel.

3. The terminal according to claim 1, wherein the radio resource control information element includes configuration of one or more PUCCH resources per bandwidth part (BWP).

4. The terminal according to claim 1, wherein the reporting is triggered by a specific field in the downlink control information.

5. A radio communication method of a terminal, the radio communication method comprising the steps of:
receiving information on a physical uplink control channel (PUCCH) resource by at least one of downlink control information and a radio resource control information element; and
reporting aperiodic channel state information (A-C SI) by using the PUCCH resource.

6. A base station comprising:
a transmission section that transmits information on a physical uplink control channel (PUCCH) resource by at least one of downlink control information and a radio resource control information element; and
a reception section that receives a report of aperiodic channel state information (A-CSI) by using the PUCCH resource.

7. The terminal according to claim 2, wherein the reporting is triggered by a specific field in the downlink control information.

8. The terminal according to claim 3, wherein the reporting is triggered by a specific field in the downlink control information.
